(19) United States
(12) Patent Application Publication
(10) Pub. No.: US 2012/0322661 A1
(43) Pub. Date: Dec. 20, 2012

(54) Organized Liquid Mixture

(76) Inventors: Jaidev Rajnikant Shroff, Mumbai (IN); Vikram Rajnikant Shroff, Mumbai (IN); Prakash Mahadev Jadhav, Mumbai (IN)

(21) Appl. No.: 13/520,991

(22) PCT Filed: Jan. 10, 2011
(86) PCT No.: PCT/IN11/00019

§ 371 Date: Aug. 22, 2012

(30) Foreign Application Priority Data
Jan. 12, 2010 (IN) 90/MUM/2010

(51) Int. Cl. A01N 25/04; A01P 13/00; A01N 41/06

(52) U.S. Cl. 504/333; 504/362; 504/363

(57) ABSTRACT

Described is an agrochemical isotropic dispersion of at least two immiscible liquids comprising at least one water soluble herbicidal salt; a surfactant system comprising a sorbitan ester or an alkoxylate thereof in combination with at least one vegetable oil alkoxylate; and water and a process for the preparation thereof, also described is an agrochemical microemulsion formulation comprising the isotropic dispersion and a method for controlling a weed at a desired location comprising applying the microemulsion formulation.

### FIELD OF THE INVENTION

The present invention relates to a high loaded stable agrochemical composition comprising a water soluble herbicidal active ingredient comprised within an organized liquid mixture. More particularly, the present invention relates to a storage stable agrochemical composition comprising a water soluble herbicidal active ingredient and a surfactant system comprised within an organized isotropic dispersion of a plurality of immiscible liquids.

### BACKGROUND OF THE INVENTION

The challenge involved in developing commercially acceptable products containing agriculturally active compounds continues to increase due to the rapid emergence of more complex customer and regulatory requirements. These agricultural compositions must exhibit excellent chemical stability and must also maintain a high level of physical stability under a severe range of storage and use conditions. Handling of a liquid product in bulk storage facilities represents a special challenge because the product can be subject to high shear forces at both high and low temperatures. This emerging area of performance is critical to customer satisfaction and commercial success with a product since poor compatibility in the final use mixture can cause blockage of sprayer screens and nozzles, preventing proper application of the product. At the same time the demand on the agrochemical composition performance has been increasing, the number of auxiliary chemicals approved for use in agrochemical compositions by the various regulatory authorities has been decreasing due to more stringent standards for the toxicological and ecological properties of these materials.

The agrochemical compositions are generally prepared using one or more adjuvants sometimes in specific combinations to provide optimum biological activity. Much has been published on the selection of adjuvants and specific combinations of adjuvants that have been designed to achieve particular effects with individual and classes of agrochemicals. Sometimes higher the concentration of the active agrochemical and its associated adjuvants, greater is the probability that the stability of the formulation may be disturbed and one or more component separates out, for example as a discrete phase. In general, the separation of a discrete phase from an agrochemical is highly undesirable, particularly when the formulation is sold in bulk containers. In these circumstances it is virtually impossible to re-homogenize the formulation and to achieve even distribution of the components on dilution and spraying. Furthermore, the formulation especially when in the form of a dispersion of two or more immiscible fluids, must be stable in respect of storage for prolonged periods in both hot and cold climates. These all factors present formidable problems to the formulator.

U.S. Pat. No. 6,117,820 teaches an aqueous agrochemical concentrate formulation comprising a) an agrochemical electrolyte such as salts of glyphosate, fomesafen, glufosinate, paraquat or bentazone, b) an alkoxylated adjuvant, c) an alkylglycoside and d) a co-surfactant which interacts with the alkylglycoside to form a structured aqueous system. Likewise, U.S. Pat. No. 6,207,617B1 teaches the use of polyoxyethylene alkylether or alkenylether surfactant system to make a stable aqueous concentrate formulation. However, these patents fail to appreciate a surfactant system provided according to this invention. Moreover, there is an appreciable need in the art for a formulation that is a high loaded and solvent-free composition of water soluble herbicide which is also physico-chemically and thermodynamically stable. Moreover, it is generally known that a surfactant “salts out” in the presence of a water soluble salt. The alkylglycoside present in the compositions of the invention described in the above patents prevent a “salting out” of the surfactant by forming a complex with the co-surfactant. It is thus desired to provide a formulation which does not cause any salting out of a surfactant in the presence of a salt without the need for the presence of an alkylglycoside.

It has also been observed in the past that a high loading of the active ingredients in a formulation always results into an unstable product on storage. In contrast, the surfactant system of the present invention is able to accommodate a high concentration of water soluble herbicidal active ingredients and the resultant formulations surprisingly also found to be storage stable.

There is a need in the art for surfactant systems to develop a formulation that has both unique performance characteristics and a good environmental safety profile. The said surfactant system is also required to possess a good physicochemical stability even at higher concentrations.

It is advantageous according to an embodiment of the present invention to prepare a formulation which is thermodynamically stable and an isotropic dispersion of one liquid into at least another immiscible liquid. These formulations are conventionally also prepared as microemulsion formulations, which are formed spontaneously on simple mixing. These microemulsion formulations are stabilized by an adsorbed surfactant film at the liquid-liquid interface. However, the present invention concerns any isotropic dispersion of at least two immiscible liquids wherein the active ingredient is partitioned between the micro-domains of said liquids, which may be spontaneously or coercively formulated. In an embodiment, the formulations according to the present invention represent a microemulsion formulation.

However, it is known to be difficult to prepare a stable microemulsion of a water soluble herbicide. The resultant microemulsion of a water soluble herbicide is also required to meet the requirements of the end user for effective weed control including good crop safety.

Another challenge is that surfactants must be carefully selected for a number of reasons: (a) as emulsifying agents to physically stabilize the formulation, (b) as dispersants to prevent aggregation of oil particles when the formulation is diluted in water for application to plants, and (c) as adjuvants to enhance herbicidal efficacy of one or more active ingredients, for example by improving retention on or adhesion to foliar surfaces of the applied composition or by improving penetration of the active ingredient(s) through the cuticles to the interior of plant foliage and (d) successfully accommodating the high load of active ingredient. It is clear that selecting a surfactant so as to meet all these objectives is in itself a challenging task.

Thus all these challenges have now surprisingly been met by an invention set out immediately below.

### ADVANTAGES OF THE INVENTION

An advantage of the present invention is a storage stable and high active ingredient loaded water soluble herbicidal organized liquid mixture.

Another advantage of the present invention is a stable formulation comprising a water soluble herbicide which is devoid of any haziness or phase separation.

Yet another advantage of the invention is a formulation of water soluble herbicides having enhanced bioefficacy.

Yet another advantage of the said surfactant system is that it is solvent free and is highly ecofriendly.

Further advantage of the present invention is a process for preparing a formulation comprising a water soluble herbicide alone or in combination as described herein in this specification.

Another advantage of the invention is a surfactant system having very low freezing point, which when utilized in agrochemical formulations imparts good stability to the final product even at low temperatures and high drug loading.

Yet another advantage of the present invention is an agricultural composition that exhibits excellent chemical and physical stability under a severe range of storage and use conditions.

These and other advantages of the present invention would be apparent from the description of the invention set out hereinafter.

### SUMMARY OF THE INVENTION

Accordingly, in one aspect, the present invention provides an agrochemical isotropic dispersion of at least two immiscible liquids, said dispersion comprising:
(a) at least one water soluble herbicide salt; and
(b) a surfactant system comprising a sorbitan ester or an alkoxylate thereof in combination with at least one vegetable oil alkoxylate;
(c) optionally, a predetermined amount of an oil; and
(d) water;
   wherein said water soluble herbicide salt is partitioned between the micro-domains of each said liquid.

In another aspect, the present invention provides an agrochemical isotropic dispersion of at least two immiscible liquids, said dispersion comprising:
(a) at least one water soluble herbicide salt;
(b) a surfactant system comprising a sorbitan ester or an alkoxylate thereof in combination with at least one vegetable oil ethoxylate; and
(c) at least one alkyl cellosolve co-solvent;
(d) optionally, a predetermined amount of an oil; and
(e) water;
   wherein said water soluble herbicide salt is partitioned between the micro-domains of each said liquid.

In yet another aspect, the present invention provides a process for the preparation of an agrochemical isotropic dispersion of at least two immiscible liquids, said process comprising:
(a) mixing a sorbitan ester or an alkoxylate thereof with at least one vegetable oil ethoxylate under stirring to obtain a uniform mixture;
(b) mixing herbicidally effective amount of at least one water soluble herbicide salt and optionally mixing a predetermined quantity of at least one alkyl cellosolve co-solvent to the mixture of step (a); and
(c) adding a predetermined quantity of a first liquid and a predetermined amount of a second liquid immiscible with said first added liquid to the solution of step (b).

In a further aspect, the present invention provides a process for the preparation of an agrochemical isotropic dispersion of at least two immiscible liquids, said process comprising:
(a) mixing an effective amount of a water soluble herbicidal active ingredient with a predetermined quantity of an alkyl cellosolve in a predetermined amount of a first liquid; and
(b) adding a sorbitan ester or an alkoxylate thereof, at least a vegetable oil ethoxylate and a predetermined amount of a second liquid immiscible with first added liquid under stirring, sequentially or concurrently, to the mixture of step (a) to obtain a clear isotropically dispersed liquid mixture.

In yet another aspect, the present invention provides a method for controlling an undesired weed at a location comprising applying an isotropic liquid dispersion according to the present invention at the desired location.

In an embodiment, the present invention provides an agrochemical microemulsion formulation comprising:
(a) a herbicidally effective amount of fomesafen sodium;
(b) a surfactant system comprising a sorbitan ester or an alkoxylate thereof in combination with at least one vegetable oil ethoxylate; and
(c) at least one alkyl cellosolve co-solvent;
(d) optionally, a predetermined amount of an oil; and
(e) water;
   wherein said herbicidally effective amount of fomesafen sodium is partitioned between the micro-domains of said added water and oil.

### DETAILED DESCRIPTION OF THE INVENTION

The present inventors have surprisingly found that a combination of a sorbitan ester or an alkoxylate thereof with a vegetable oil ethoxylate, provides a stable dispersion of a liquid mixture comprising a water soluble herbicidal salt in the presence of predetermined amounts of at least two immiscible liquids. In an embodiment, the formulations according to the present invention comprise water as the first liquid and a predetermined oil, which is immiscible with water, as the second liquid. It has been found that a formulation comprising this surfactant system and a water soluble herbicide is physicochemically stable even at a high loading of the active ingredient. Further, there was no change in the chemical and physical stability of such formulations even after a prolonged storage.

In an embodiment, no additional oil component may be added extraneously when the hydrocarbon of the added surfactant system constitutes the oil microdomains. However, it is advantageous if a predetermined amount of an oil is added. As used herein, the term “oil phase” or “oil microdomain” or other such terms shall denote the oil component constituted by the extraneously added oil component or may be constituted by the hydrocarbon portion of the externally added surfactant system.

In an embodiment, the liquid dispersion of the invention is a microemulsion, and further advantageously is an oil-in-water microemulsion. It has been found that a combination of a sorbitan ester or an alkoxylate thereof with a vegetable oil ethoxylate provides a stable micellar solubilization of a water soluble agrochemical salt. It was further considered surprising that the water soluble agrochemical resided in the micro-domains of each said immiscible liquid present in the formulations of the present invention. The thermodynamic partitioning of a herbicidal water soluble salt in the aqueous phase and particularly its micellar solubilization in the hydrocarbon phase was considered surprising. The formulations according to the present invention may be presented as an herbicidal concentrate such that it is normally diluted with a suitable volume of water before application, for example by spraying on to foliage of plants. The formulations according to the present invention advantageously comprise at least about 5% and up to about 50% by weight of a water-soluble herbicide.

In an embodiment, the formulations according to the present invention comprise at least about 45% purity by weight, more advantageously at least about 40% purity by weight of the water soluble herbicidal active ingredient.

Another advantage of the present formulations is that these formulations are high drug loaded and yet free of a conventional solvent. More advantageously, water soluble herbicide is salt of fomesafen, most advantageously sodium salt of fomesafen.

Fomesafen sodium is chemically known as sodium (EZ)-5-(2-chloro-α,α,α-trifluoro-p-tolyloxy)-N-mesyl-2-nitrobenzenecarboximidate having molecular formula C₁₅H₉ClF₃N₂NaO₆S. Fomesafen and its salts thereof are widely used amide herbicides.

The present invention thus provides a storage stable, high loaded formulation comprising at least one water soluble herbicide salt and a surfactant system of a sorbitan ester or an alkoxylate thereof in combination with a vegetable oil ethoxylate. The formulation according to the present invention is, in a most advantageous embodiment though not necessarily, a microemulsion. Microemulsions are clear, stable, isotropic liquid mixtures of oil, water and surfactant, frequently in combination with a cosurfactant.

In an embodiment, the sorbitan ester is alkoxylated. Advantageously, both alkoxylated sorbitan ester and vegetable oil alkoxylate are derived from a vegetable origin, and hence are eco-friendly and are also biodegradable in nature. It was considered surprising that a combination of a sorbitan ester alkoxylate with a vegetable oil ethoxylate provided a stable micellar stabilization of a water soluble herbicidal salt distributed in the aqueous phase as well as in the micellar hydrocarbon phase. In contrast, it was observed by the present inventors that when alkoxylated sorbitan ester was used alone in the composition, the resultant system was a clear solution and not a dispersion and generated considerable amount of frothing (Refer table 1, 2, 3 and 4 below). Likewise, the use of only alkoxylated vegetable oil did not result into a dispersion system and the result of such system was a turbid solution. It was indeed surprising that a combination of alkoxylated sorbitan ester along with a vegetable oil alkoxylate provided a storage stable and high loaded liquid-liquid isotropic dispersed formulation. It was further found that the ethoxylated sorbitan monooleate component of the surfactant system according to the present invention reduced the contact angle between the active ingredient and surface of leaf. This led to an increase in the contact surface between the active ingredient particles and the leaf surface with a consequent increase in the drug penetration.

It was further considered surprising that the surfactant system of the present invention along with oil, whether extraneously added or inherently generated from the hydrocarbon portion of the surfactant system, and water resulted in an emulsion system in the absence of a water soluble herbicide but did not result into an isotropic liquid-liquid desired by the present inventors. It was only subsequent to the addition of the water soluble herbicide to the above emulsion that a micellar stabilized isotropic liquid-liquid dispersion was obtained.

Without wishing to be bound by theory, it is believed that in the absence of the water soluble active ingredient, the geometric packing of the surfactant system in the presence of at least two liquids is incapable of self-aggregating into liquid micro-domains. A portion of the added herbicidal active ingredient penetrates the palisade layer of the surfactant system and favors the self-aggregation of the surfactant system to form a organized self-aggregated micro-domains, which was unexpected and considered surprising.

In an embodiment, the sorbitan ester is alkoxylated. The alkoxylated sorbitan esters are hydrophilic compounds displaying high HLB values and possess a remarkable affinity for water. The present invention enables different HLB values desired by the formulator to be achieved by selecting the type of ester moiety and the mole number of ethylene oxide.

In an embodiment, the alkoxylate is an ethoxylate. In another embodiment, the sorbitan ester is a fatty acid ester. For example, the sorbitan ester may be sorbitan monooleate or sorbitan linolate. The ester may alternately also be selected from laurate, myristate, stearate, oleate, linolate, laurate and palmitate.

In an embodiment, the alkoxylated sorbitan ester is ethoxylated sorbitan monooleate.

It is known in the art that solutions are more stable than dispersions. However a clear solution system has a tendency to precipitate the active ingredient out of the formulation with the small variation in temperature or pH. The precipitation of the active ingredient increases the tendency of the formulation to turn turbid. The active ingredient precipitated out of the system in this manner many times settles down in the container and forms sediment. A formulation in the form of a clear solution not only gets evaporated completely but also gets washed out easily in rains. It has been found that the isotropic dispersion of at least two immiscible liquids according to the invention are more stable to rain wash and do not allow the active ingredient to precipitate out of the formulation.

The surfactant system of the present invention additionally comprises a vegetable oil alkoxylate. In an embodiment, the alkoxylate is an ethoxylate. The vegetable oil ethoxylate is a lipophilic surfactant which when present in the formulations according to the present invention without the sorbitan ester alkoxylate results in the formation of a system having larger globule size, thereby decreasing the penetration of active ingredients across the cell wall, in turn reducing the efficacy of the formulation. It also helps in reducing foaming and solubilizing any active ingredient material that may be present in the system which can cause creaming or separation or sedimentation. The vegetable oil may be any oil of vegetable origin that is known in the art. The choice of the vegetable oil is not considered particularly limiting and may be appropriately selected by a person skilled in the art without departing from the scope of the invention.

In an embodiment, the vegetable oil ethoxylate may be selected from ethoxylates of a group of vegetable oil comprising palm oil, soybean oil, rapeseed oil, sunflower seed oil, peanut oil, cottonseed oil, palm kernel oil, coconut oil, olive oil and castor oil. In yet another embodiment, the vegetable oil ethoxylate is castor oil ethoxylate.

Thus, the surfactant system of the present invention permits a micellar solubilization of a high loading of the partitioned water soluble agrochemical in the formulation, which was hitherto not possible. Further, it has been observed in an embodiment that the fomesafen sodium salt active ingredient always contains a small amount of fomesafen acid. This small amount of fomesafen acid remains suspended in the final composition as small particles and interferes with the formation of a clear dispersion, which is undesirable. It is believed that the vegetable oil ethoxylate comprised within the surfactant system of the invention solubilizes any fomesafen acid present in the formulation and helps suspending the fomesafen acid particles. It further acts as a carrier for the active ingredient and ensures that the application displays superior rainfastness to yield better results.

In an embodiment, the vegetable oil alkoxylate and ethoxylated sorbitan ester are present in a weight ratio of from about 10:90 to about 90:10.

Still more advantageously, it was found that surprising results are associated with the surfactant system according to the present invention wherein equal quantities of alkoxylated sorbitan monooleate and vegetable oil alkoxylate were used. It was found that such a surfactant system resulted into an advantageous formulation having desirable properties.

It was also found that the surfactant system according to the present invention depressed the freezing point of the resulting formulation thereby conferring-superior flow temperature stability on the resultant formulation. This combination surfactant system was found to remain in a liquid state even at lower temperature while other conventional surfactants tend to freeze at such temperatures. The formulations according to the present invention were thus found to be stable even at 5° C., while other known surfactant systems are known to freeze even at 10° C. For example, lauryl alcohol ethoxylate is known to freeze at 30° C., styrenated phenol ethoxylate is known to freeze at 25° C. while castor oil ethoxylate freezes at 25° C. However, the low freezing point of the surfactant system of the present invention could be attributed to the presence of ethoxylated sorbitan ester. It is frequently seen that surfactants having SAP value around 50 are solid at 25° C., but ethoxylated sorbitan monooleate having SAP value around 50 is liquid at 25° C. In contrast, the ethoxylate of sorbitan palmitate or ethoxylate of sorbitan stearate are solid at 25° C.

SAP value referred in this specification is a saponification value (or “saponification number”), representing the number of milligrams of potassium hydroxide or sodium hydroxide required to saponify 1 g of fat under the conditions specified. It is a measure of the average molecular weight (or chain length) of all the fatty acids present.

In one of the embodiments, at least one of the liquids present within the formulations of the present invention is water while the second liquid is immiscible with water. The aqueous phase in the formulations of the present invention comprises water having dissolved therein a portion of the selected water-soluble herbicide or mixtures thereof. The term “water-soluble” as used herein relation to a herbicide or salt thereof means having a defined known solubility in deionized water at 20° C. In an embodiment, the water-soluble herbicides have a herbicidally active acid or anionic moiety and are present in the composition of the invention in the form of one or more water-soluble salts. The aqueous phase can optionally contain, in addition to the water-soluble herbicide, other salts contributing to the ionic strength of the aqueous phase.

A particular group of water-soluble herbicides are those that are normally applied post-emergence to the foliage of plants. Systemic movement in plants can take place via apoplastic (non-living) pathways, including within xylem vessels and in intercellular spaces and cell walls, via symplastic (living) pathways, including within phloem elements and other tissues composed of cells connected symplastically by plasmodesmata, or via both apoplastic and symplastic pathways. For foliar-applied systemic herbicides, the most important pathway is the phloem, and the present invention is believed to provide the greatest benefits where the water-soluble herbicide is phloem-mobile.

Illustratively water-soluble herbicides that can be used in compositions of the invention include water soluble salts of acifluorfen, acrolein, amitrole, asulam, benazolin, bentazon, bialaphos, bromacil, bromoxynil, chloramben, chloroacetic acid, clopyralid, 2,4-D, 2,4-DB, dalapon, dicamba, dichlorprop, difenzoquat, diquat, endothall, fenac, fenoxaprop, flamprop, flumiclorac, fluoroglycofen, flupropanate, fomesafen, fosamine, glufosinate, glyphosate, imazameth, imazamethabenz, imazamox, imazapic, imazapyr, imazaquin, imazethapyr, ioxynil, MCPA, MCPB, mecoprop, methylarsonic acid, naptalam, nonanoic acid, paraquat, picloram, quinclorac, sulfamic acid, 2,3,6-TBA, TCA, triclopyr and water-soluble salts thereof.

In an embodiment, the water soluble herbicide component according to the present invention may be combination of at least two herbicides such as described hereinabove. In a further embodiment, the water soluble herbicide component is acifluorfen sodium in combination with an agriculturally acceptable salt of glyphosate; acifluorfen sodium in combination with an agriculturally acceptable salt of bentazone or an agriculturally acceptable salt of glyphosate with an agriculturally acceptable salt of paraquat such as for example, paraquat dichloride or paraquat dimetilsulfate; a water soluble salt of asulam such as asulam sodium in combination with water soluble salt of any other herbicide; water soluble salt of endothall acid in combination with water soluble salt of any other herbicide salt of triclopyr in combination with a water-soluble salt of any other herbicide.

A particular water soluble herbicide used in the present invention is the sodium salt of fomesafen.

The formulations of the present invention optionally include a co-solvent of the alkyl cellosolve group. They are generally used to impart required viscosity to the highly loaded herbicidal isotropic liquid dispersion of the present invention. The cellosolve co-solvents according to the present invention include, but are not limited to, methyl cellosolve, ethyl cellosolve and Butyl cellosolve. The cellosolve concentration may vary with the active ingredient used in the formulation (Table 4).

Thus, in another aspect, the present invention provides an agrochemical isotropic dispersion of at least two immiscible liquids, said dispersion comprising:
(a) at least one water soluble herbicide salt;
(b) a surfactant system comprising a sorbitan ester or an alkoxylate thereof in combination with at least one vegetable oil ethoxylate;
(c) at least one alkyl cellosolve co-solvent;
(d) optionally, a predetermined amount of an oil; and
(e) water;
   wherein said water soluble herbicide salt is partitioned between the micro-domains of each said liquid.

In another embodiment, the formulations of the present invention optionally includes an additional water-soluble herbicide.

In any of the embodiments described hereinabove, the choice of an oil, when present, is not particularly limiting. In an embodiment, the oil may be selected from the group comprising oleic acid, banole oil and liquid paraffin oil although other oils are not excluded.

In an embodiment, the amount of the sorbitan ester alkoxylate, vegetable oil ethoxylate, cellosolve co-solvent and water is not particularly limiting and may be selected by a skilled formulator depending on the amount of water soluble herbicidal salt present within the formulation.

In another exemplary embodiment, the amounts of the sorbitan ester alkoxylate, vegetable oil ethoxylate, cellosolve co-solvent and water are exemplified in the examples 1-3 appearing hereinafter.

In another aspect, the present invention provides a process for the preparation of an agrochemical isotropic dispersion of at least two immiscible liquids, said process comprising:
(a) mixing a sorbitan ester or an alkoxylate thereof with at least one vegetable oil ethoxylate under stirring to obtain a uniform mixture;
(b) mixing herbicidally effective amount of at least one water soluble herbicide salt and optionally mixing a predetermined quantity of at least one alkyl cellosolve co-solvent to the mixture of step (a); and
(c) adding a predetermined quantity of a first liquid and a predetermined amount of a second liquid immiscible with said first added liquid to the solution of step (b).

In another aspect, the process according to the present invention comprises mixing an effective amount of water soluble herbicidal active ingredient with a predetermined quantity of an alkyl cellosolve in a first liquid. Subsequently, ethoxylated sorbitan ester and vegetable oil ethoxylate along with the second liquid immiscible with the first added liquid are added one by one to this solution under stirring to obtain a clear formulation.

Thus, in this aspect, the present invention provides a process for the preparation of an agrochemical microemulsion formulation comprising:
(a) mixing an effective amount of water soluble herbicidal active ingredient with a predetermined quantity of alkyl cellosolve in water;
(b) adding ethoxylated sorbitan monooleate, a vegetable oil ethoxylate and a predetermined amount of a second liquid immiscible with said first added liquid under stirring, sequentially or concurrently, to the mixture of step (a) to obtain a clear formulation.

In an embodiment, the isotropic dispersed liquid mixture obtained in step (b) of this aspect may be optionally filtered.

In one embodiment, the isotropic dispersed liquid mixture according to the present invention may be spontaneously or coercively formed on a simple mixing of the components. In this embodiment, the formulation is a microemulsion formulation wherein the herbicidal active ingredient may be distributed in the aqueous and oil phase simultaneously.

In another aspect, the isotropic dispersed liquid mixture according to the present invention comprises a mixture of two mutually immiscible liquids, which are water and oil.

However, a thermodynamically stable dispersion according to the present invention is possible using more than two immiscible liquids, which could be stabilized by the adsorbed surfactant system of the present invention at each liquid-liquid interface. In this embodiment, the selective surfactant system of the present invention stabilizes the micro-domains present in each said immiscible liquid, thereby enabling each said microdomain present within three or more immiscible liquids to receive and accommodate a portion of the herbicidal active ingredient. This distribution of the water soluble herbicidal active ingredient within the microdomains in each immiscible liquid portion was considered surprising.

The selection of application rates for a composition of the invention containing a specific water-soluble herbicide to provide a desired provide a desired level of herbicidal activity is within the skill of an ordinary agricultural technician. One skilled in the art will recognize that individual plant conditions, weather and growing conditions, as well as the specific exogenous chemical substance selected, can affect the results achieved in using a composition of the present invention. In an embodiment, the application rates for fomesafen sodium varies from about 100 to about 2500 g a.e./ha, more particularly from about 250 to about 1500 g a.e./ha.

In another aspect, the present invention provides a method for controlling an undesired weed at a location. This method comprises applying the formulations according to the present invention at the desired location.

The method of the present invention where the water-soluble herbicide is fomesafen sodium is applicable to any and all plant species on which fomesafen sodium is biologically effective as a herbicide. This encompasses a very wide variety of plant species worldwide.

Herbicidal compositions of water soluble herbicides alone or in combination are used to control a very wide variety of plants worldwide. The high loaded water soluble herbicidal compositions of the present invention can be diluted at the time of application and can used effectively to control one or more plant species of one or more of the following genera without restriction: Abutilon, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusine, Elymus, Equisetum, Erodium, Helianthus, Imperata, Ipomoea, Kochia, Lolium, Malva, Oryza, Ottochloa, Panicum, Paspalum, Phalaris, Phragmites, Polygonum, Portulaca, Pteridium, Pueraria, Rubus, Salsola, Setaria, Sida, Sinapis, Sorghum, Triticum, Typha, Ulex, Xanthium and Zea.

Particularly important annual broadleaf species for which the formulations of water soluble herbicides are exemplified without limitation are the following: velvetleaf (Abution theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), morningglory (Ipomoea spp.), kochia (Kochia scoparia), mallow (Malva spp:), wild buckwheat, smartweed, etc. (Polygonum spp.), purslane (Portulaca spp.), russian thistle (Salsola spp.), sida (Sida spp.), wild mustard (Sinapis arvensis) and cocklebur (Xanthium spp.).

Particularly important annual narrowleaf species for which the formulations of water soluble herbicides compositions are exemplified without limitation are the following: wild oat (Ayena fatua), carpetgrass (Axonopus spp.), downy brome (Bromus tectorum), crabgrass (Digitaria spp.), bamyardgrass (Echinochloa crusgalli), goosegrass (Eieusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays).

Particularly important perennial broadleaf species for which glyphosate compositions are exemplified without limitation are the following: mug wort (Artemisia spp.), milkweed (Asclepias spp.), Canada thistle (Cirsium arvense), field bindweed (Convolvulus arvensis) and kudzu (Pueraria spp.).

Particularly important perennial narrowleaf species for which fomesafen compositions are exemplified without limitation are the following: brachiaria (Brachiaria spp.), bermudagrass (Cyriodon dactylon), yellow nutsedge (Cyperus esculentus), purple nutsedge (C. rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.).

Other particularly important perennial species for which fomesafen compositions are exemplified without limitation are the following: horsetail (Equisetum spp.), bracken (Pteridium aquilinum), blackberry (Rubus spp.) and gorse (Ulex europaeus).

Thus, water soluble herbicidal compositions of the present invention, and a method for treating plants with such compositions, can be useful on any of the above species. In a particular contemplated method, a plant treatment composition of the invention comprising fomesafen sodium is applied to foliage of crop plants genetically transformed to tolerate fomesafen sodium, and simultaneously to foliage of weeds or undesired plants growing in close proximity to such crop plants.

Application of plant treatment compositions to foliage of plants is accomplished by spraying, using any conventional means for spraying liquids, such as spray nozzles or spinning-disk atomizers. Compositions of the present invention can be used in precision farming techniques, in which apparatus is employed to vary the amount of exogenous chemical substance applied to different parts of a field, depending on variables such as the particular plant species present, plant growth stage, soil moisture status, etc. In one embodiment of such techniques, a global positioning system operated with the spraying apparatus can be used to apply the desired amount of the composition to different parts of a field.

A plant treatment formulation according to the present invention is diluted enough to be readily sprayed using standard agricultural spray equipment. Suitable application rates for the present invention vary depending upon such factors as the type and concentration of active ingredient and the plant species involved. Useful rates for applying an aqueous composition to a field of foliage can range from about 25 to about 1,000 liters per hectare (1/ha), particularly about 50 to about 300 1/ha, by spray application.

### EXAMPLES

The following examples are for the purposes of illustration only and are not intended to limit the scope of the present invention.

The best mode of making and using the present invention are described in the following examples. These examples are given only to provide direction and guidance in how to make and use the invention, and are not intended to limit the scope of the invention in any way.

### Example: 1

| Sr. No. | Raw material | Amount (%, w/w) |
|---|---|---|
| 1 | Fomesafen salt | 42.3 |
| 2 | Water | 14.7 |
| 3 | Methyl Cellosolve | 10.00 |
| | co-solvent | |
| 4 | Ethoxylated sorbitan | 23.43 |
| | monooleate | |
| 5 | Vegetable oil | 9.57 |
| | ethoxylate(Grade I) | |
| | Total | 100 |

### Example: 2

### Microemulsion of Fomesafen Sodium (44.2 ME)

| | Amount (%, w/w) |
|---|---|
| Ingredient | |
| Fomesafen Sodium salt | 44.2 |
| Water | 13.8 |
| Methyl Cellosolve | 12.00 |
| Ethoxylated Sorbitan Monooleate | 30.00 |
| Oleic Acid ester ethoxylate | |
| Total | 100 |
| Physicochemical properties | |
| Appearance | Light brown clear |
| | viscous liquid |
| Cold study −5° C. | Flowable viscous |
| | liquid |
| Cold study 5° C. | Flowable slight |
| | viscous liquid |
| AHS study 54° C. | Flowable liquid, |
| | Stable |

### Example: 3

### For Microemulsion of Fomesafen Sodium 22.1 ME

| Ingredient | Percent (w/w) |
|---|---|
| Fomesafen sodium (purity 57%) | 39.50 |
| Vegetable oil ethoxylate | 18.15 |
| Sorbitan mono-oleate | 14.85 |
| Oleic acid | 2.00 |
| Methyl cellosolve | 12.00 |
| Water | 13.50 |

### Process for Preparing Microemulsion of Water Soluble Herbicidal Exemplified Above in Example 1, 2 and 3:

(a) Ethoxylated sorbitan monooleate and a vegetable oil ethoxylate were mixed together, which was stirred to get the uniform mixture in a provided liquid, which was immiscible with water.
(b) Herbicidally effective amounts of fomesafen sodium and predetermined quantity of cellosolve were added to the mixture of surfactants of step (a).
(c) A required quantity of water was added to the solution of step (b) to get a clear formulation.

TABLE 1
14 days Heat stability data of Fomesafen 22.1
ME in comparison with a commercially known microemulsion
formulation of the same strength.

| | Vegetable | Vegetable | Vegetable | Vegetable | |
|---|---|---|---|---|---|
| | oil | oil | oil | oil | |
| | ethoxylate | ethoxylate | ethoxylate | ethoxylate | Known |
| | of | of | of | of | formu- |
| Properties | Grade I | Grade II | Grade III | Grade IV | lation |
| Appearance | Light | Light | Light | Light | Light |
| | Brown Liq | Brown Liq | Brown Liq | Brown Liq | Brown Liq |
| Fomesafen | 22.45 | 22.83 | 22.45 | 22.21 | 23.29 |
| sodium | | | | | |
| P^{H} of 1% | 7.04 | 7.09 | 7.09 | 7.09 | 7.22 |
| aq. Su | | | | | |
| 0 day | | | | | |
| Density | 1.1073 | 1.1013 | 1.0912 | 1.0852 | 1.0910 |
| Persistence | 5 ml | 5 ml | 5 ml | 5 ml | 5 ml |
| Foam | | | | | |
| RPM | 100 | 100 | 100 | 100 | 100 |
| Torque (Nm) | 24 | 21.8 | 29 | 26.4 | 68.6 |
| Viscosity | 72.3 | 65.4 | 86.7 | 79.2 | 208.5 |
| (poise) | | | | | |

Grade I: Castor oil ethoxylate(20 mole)
Grade II: Castor oil ethoxylate (30 mole)
Grade III: Talloil ethoxylate
Grade IV: Oleic Acid ester ethoxylate

### Example 4

Using the process described above, a 22.1 microemulsion formulation comprising fomesafen sodium was prepared with the following compositions.

| Ingredient | Percentage (w/w) |
|---|---|
| Fomesafen sodium (purity 57%) | 39.50 |
| Vegetable oil ethoxylate | 18.15 |
| Sorbitan mono-oleate | 14.85 |
| Oleic acid | 2.00 |
| Water | 25.50 |

This formulation was a light brown, clear viscous liquid with 675.5 cP viscosity with 56.3% torque. The formulation remained clear, viscous and flowable liquid when evaluated for its cold stability at 5° C. for 5 days. It also remained light brown clear viscous liquid when evaluated for its heat stability at 54° C. for 14 days. The microemulsion remained bluish to hazy translucent at 0 hour, 30 minutes and 24 hours when evaluated at 20 ppm, 342 ppm and 500 ppm particle size.

### Example 5

| Ingredient | Percentage (w/w) |
|---|---|
| Fomesafen sodium (purity 57%) | 39.50 |
| Vegetable oil ethoxylate | 13.0 |
| Sorbitan monooleate | 20.0 |
| Oleic acid | 2.00 |
| Butyl cellosolve | 12 |
| Water | 13.50 |

This formulation was a light brown, clear liquid with 201-208 cP viscosity with 47.5-50% torque. The formulation remained clear and flowable liquid when evaluated for its cold stability at 5° C. for 5 days. It also remained clear flowable liquid when evaluated for its cold stability at −5° C. at 24 hours, while it was a light brown clear liquid when evaluated for its heat stability at 54° C. for 14 days. The microemulsion remained bluish to slightly hazy translucent at 0 hour, 30 minutes and 24 hours when evaluated at 20 ppm, 342 ppm and 500 ppm particular size

### Micellar Entrapment

A series of the experiments were conducted to establish that a combination of a sorbitan ester alkoxylate with a vegetable oil ethoxylate provided a stable micellar solubilization of the water soluble herbicide fomesafen sodium. Studies were also designed to confirm that the fomesafen sodium present within the formulation was partitioned between the micro-domains of the aqueous phase and the micellar oil phase.

The conductivity of an aqueous solution of fomesafen sodium was measured at different concentrations of fomesafen sodium. The results were plotted on a graph with measured conductivity plotted on Y-axis and the corresponding concentration on the X-axis. It was observed that the conductivity increased with the salt concentration and dropped suddenly above 0.45 g/L. It is believed that at this inflection concentration, fomesafen sodium self-aggregated to form an aggregated structure.

In another series of experiments, the formulations according to the present invention exemplified by examples 1 and 2 were tested at various concentrations of fomesafen sodium active ingredients and the resulting conductivity was measured. The results were plotted on a graph with measured conductivity plotted on Y-axis and the corresponding concentration on the X-axis. It was observed that for a given concentration of fomesafen sodium, the conductivity of the formulation according to the present invention (graph traced by small triangles) was surprisingly lower than the conductivity of an aqueous solution of fomesafen sodium (graph traced by small circles) at the same given concentration. It was believed that this surprising lowering of the conductivity of fomesafen sodium could be attributed to the entrapment of fomesafen sodium within the micellar aggregates contributed by the surfactant system of the present invention. Thus, it was found that a combination of a sorbitan ester alkoxylate with a vegetable oil ethoxylate provided a stable micellar solubilization of the water soluble herbicide fomesafen sodium. The comparison of the plots for the aqueous solution versus for the formulation of the present invention at a concentration of about 20% revealed that about 75% of formulated fomesafen sodium resided within the micellar aggregated oil phase while about 25% resided in the continuous aqueous phase. This spontaneous distribution of fomesafen sodium between the micellar aggregated oil phase and the continuous aqueous phase was considered surprising.

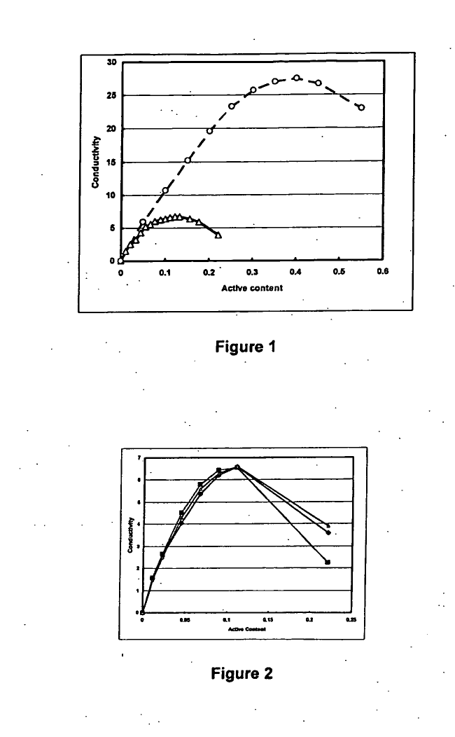

The graphs described above are presented as accompanying FIG. 1, which is self-explanatory.

Still more surprisingly, it was found that the average diameter of the micro-domains formed by self-aggregation of the second fluid (that is immiscible with water) was even less than about 0.1 micron. The reduced micro-domain size substantially increased the penetration of the active ingredient entrapped within the microdomain and enhanced the penetration of the entrapped active ingredient within the target weeds. Moreover, the size of the oil phase microdomains of the present invention afforded a large contact area with the treated surface thereby substantially improving the distribution and efficacy of the formulations according to the present invention.

Further surprisingly, it was found that the formulations according to the present displayed superior low temperature stability and remained flowable even at sub-freezing temperatures. Without wishing to be bound by theory, it is believed that the selective surfactant system of the present invention provides an ultralow interfacial surface tension between the two immiscible liquids such that the two microdomains are effectively physically separated from each other, which ensures their flowability in otherwise freezing conditions, which was considered surprising.

In another experiment, addition of an oil e.g. banole oil—100 further to an extent of upto 2% did not turn the formulation turbid i.e. the formulation remained clear confirming the existence of micellar aggregated oil microdomains into which the further added oil was accommodated. The conductance measurement of such formulations did not exhibit substantial differences as is evident from the accompanying FIG. 2 from the conductance measurement of a formulation according to the present invention in plot 1 and other formulations plots 1-3 where successive portions of water is replaced by cyclohexanol. The lowest graph and the other plot denotes water:cyclohexanol ratio of 20:80 and 80:20 respectively, while the triangular plot denotes the measured conductivity for the formulations prepared according to the present invention. These graphs did not exhibit a surprising difference further confirming the existence of a micellar aggregated oil phase into which the additionally added oil could be accommodated apart from trapping a portion of the active ingredient. It was indeed surprising that fomesafen sodium, being a water soluble salt, could be accommodated/entrapped within such micellar aggregated oil phase leading to a stabilized microemulsion formulation.

### Efficacy

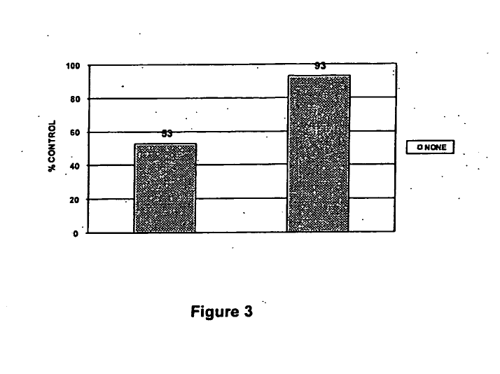

A comparative trial was conducted using the formulations according to the present invention compared to a commercially available formulation comprising the same strength (22.1%) microemulsion formulation of fomesafen sodium. The comparative formulation according to the present invention was prepared according to the exemplary formulation of Example 3 above. The comparative results are presented in the accompanying FIG. 3. It was surprisingly found that the comparative commercially available sample exhibited 53% control in sunflower whereas the formulation prepared according to the example 3 exhibited 93% control.

Wherein the aforegoing reference has been made to components having known equivalents, then such equivalents are herein incorporated as if individually set forth. Accordingly, it will be appreciated that changes may be made to the above described aspects and embodiments of the invention without-departing from the principles taught herein. Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the invention.

1. An agrochemical isotropic dispersion of at least two immiscible liquids, said dispersion comprising:
(a) at least one water soluble herbicidal salt;
(b) a surfactant system comprising a sorbitan ester or an alkoxylate thereof in combination with at least one vegetable oil alkoxylate; and
(c) water;
wherein said water soluble herbicide salt is partitioned between the micro-domains of each said liquid.

2. The agrochemical isotropic dispersion as claimed in claim 1 additionally comprising at least one alkyl cellosolve co-solvent.

3. The agrochemical isotropic dispersion as claimed in claim 1 additionally comprising a predetermined amount of an oil.

4. (canceled)

5. The agrochemical isotropic dispersion as claimed in claim 3, wherein said oil micro domains are constituted by the hydrocarbon portion of the added surfactant system.

6. The agrochemical isotropic dispersion as claimed in claim 1 wherein at least one of the said immiscible liquids is water.

7. The agrochemical isotropic dispersion as claimed in claim 6, wherein the second liquid is a predetermined oil that is immiscible with water.

8. The agrochemical isotropic dispersion as claimed claim 1, wherein said sorbitan ester is alkoxylated and selected from the group of sorbitan monooleate, sorbitan linolate, sorbitan laurate, sorbitan myristate, sorbitan stearate and sorbitan palmitate.

9. (canceled)

10. The agrochemical isotropic dispersion as claimed in claim 9, wherein said sorbitan ester is ethoxylated.

11. The agrochemical isotropic dispersion as claimed in claim 1, wherein said vegetable oil alkoxylate is vegetable oil ethoxylate selected from the group comprising ethoxylates of palm oil, soybean oil, rapeseed oil, sunflower seed oil, peanut oil, cottonseed oil, palm kernel oil, coconut oil, olive oil and castor oil.

12. (canceled)

13. The agrochemical isotropic dispersion as claimed in claim 1, wherein said surfactant system comprises sorbitan monooleateethoxylate in combination with castor oil ethoxylate.

14. The agrochemical isotropic dispersion as claimed in claim 1, wherein said sorbitan ester alkoxylate and vegetable oil alkoxylate are present in a weight ratio of from about 10:90 to about 90:10.

15. The agrochemical isotropic dispersion as claimed in claim 1 comprising equal quantities of alkoxylated sorbitan monooleate and vegetable oil alkoxylate.

16. The agrochemical isotropic dispersion as claimed in claim 1, wherein said water soluble herbicidal salt is selected from water soluble salts of acifluorfen, acrolein, amitrole, asulam, benazolin, bentazon, bialaphos, bromacil, bromoxynil, chloramben, chloroacetic acid, clopyralid, 2,4-D, 2,4-DB, dalapon, dicamba, dichlorprop, difenzoquat, diquat, endothail, fenac, fenoxaprop, flamprop, flumiclorac, fluoroglycofen, flupropanate, fomesafen, fosamine, glufosinate, glyphosate, imazameth, imazamethabenz, imazamox, imazapic, imazapyr, imazaquin, imazethapyr, ioxynil, MCPA, MCPB, mecoprop, methylarsonic acid, naptalam, nonanoic acid, paraquat, picloram, quinclorac, sulfamic acid, 2,3,6-TBA, TCA, triclopyr and combinations thereof.

17. The agrochemical isotropic dispersion as claimed in claim 16, wherein said water soluble herbicidal salt is selected from acifluorfen sodium in combination with an agriculturally acceptable salt of glyphosate; acifluorfen sodium in combination with an agriculturally acceptable salt of bentazone; an agriculturally acceptable salt of glyphosate with an agriculturally acceptable salt of paraquat; a water soluble salt of asulam such as asulam sodium in combination with water soluble salt of at least another herbicide; a water soluble salt of endothail acid in combination with water soluble salt of at least another herbicide; and a water soluble salt of triclopyr in combination with a water soluble salt of at least another herbicide.

18. The agrochemical isotropic dispersion as claimed in claim 16, wherein said water soluble herbicidal salt is fomesafen sodium.

19. The agrochemical isotropic dispersion as claimed in claim 2, wherein said alkyl cellosolve is selected from methyl cellosolve, ethyl cellosolve and butyl cellosolve.

20. The agrochemical isotropic dispersion as claimed in claim 1 comprising an isotropic dispersion of a plurality of immiscible liquids, wherein the microdomains present within each said immiscible liquid receives and accommodates at least a portion of at least one water soluble herbicidal active ingredient.

21. A process for the preparation of an agrochemical isotropic dispersion of at least two immiscible liquids, said process comprising:
(a) mixing a sorbitan ester or an alkoxylate thereof with at least one vegetable oil alkoxylate under stirring to obtain a uniform mixture;
(b) mixing a herbicidally effective amount of at least one water soluble herbicide salt and optionally mixing a predetermined quantity of at least one alkyl cellosolve co-solvent to the mixture of step (a); and
(c) adding a predetermined quantity of a first liquid and a predetermined amount of a second liquid immiscible with said first added liquid to the solution of step (b).

22. A process for the preparation of an agrochemical isotropic dispersion of at least two immiscible liquids, said process comprising:
(a) mixing a herbicidally effective amount of at least one water soluble herbicidal active ingredient with a predetermined quantity of an alkyl cellosolve in a first liquid;
(b) adding an alkoxylated sorbitan ester and vegetable oil alkoxylate along with a second liquid that is immiscible with the first added liquid to the solution obtained in step (a) under stirring to obtain a clear formulation.

23. An agrochemical microemulsion formulation comprising the isotropic dispersion as claimed in claim 1.

24. The agrochemical microemulsion formulation as claimed in claim 23, wherein said microemulsion is an oil-in-water microemulsion.

25. The agrochemical microemulsion formulation as claimed in claim 23 comprising at least about 5% and up to about 50% by weight of at least one water-soluble herbicidal salt.

26. The agrochemical microemulsion formulation as claimed in claim 23 wherein the average diameter of the micro-domains formed by self-aggregation of the second fluid is less than about 0.1 micron.

27. A method for controlling an undesired weed at a location comprising applying the formulation as claimed in any one of the claim 23, at the desired location.

28. The method as claimed in claim 26 wherein a predetermined application rate of the formulation administers from about 100 g/Ha to about 2500 g/Ha of fomesafen sodium.

29. The method as claimed in claim 27 comprising applying the formulation as claimed in any one of the claims 23, 24 or 25 to the foliage of crop plants genetically transformed to tolerate fomesafen sodium, and simultaneously applying the said formulation to foliage of weeds or undesired plants growing in close proximity to crop plants.
